(19) United States
(12) Patent Application Publication
(10) Pub. No.: US 2013/0139441 A1
(43) Pub. Date: Jun. 6, 2013

(54) SUPPORT ASSEMBLY FOR A HOUSEHOLD APPLIANCE

(71) Applicants: Sven Baacke, Munchen (DE); Sebastien Flesch, Gerstheim (FR); Gerd Wilsdorf, Olching (DE)

(72) Inventors: Sven Baacke, Munchen (DE); Sebastien Flesch, Gerstheim (FR); Gerd Wilsdorf, Olching (DE)

(73) Assignee: BSH BOSCH UND SIEMENS HAUSGERÄTE GMBH, Munich (DE)

(21) Appl. No.: 13/814,750

(22) PCT Filed: Aug. 16, 2011
(86) PCT No.: PCT/EP2011/064056

§ 371 Date: Feb. 7, 2013

(30) Foreign Application Priority Data
Aug. 20, 2010 (DE) 10 2010 039 591.9

(51) Int. Cl. F24C 15/04; B32B 3/04; B32B 3/26; E06B 5/00; F24C 7/04

(52) U.S. Cl. CPC F24C 15/04; E06B 5/00; F24C 7/046; B32B 3/266; B32B 3/04
USPC 49/70; 49/501; 219/452.12; 428/603; 428/596; 428/138; 428/177

(57) ABSTRACT

A support assembly for use in a household appliance includes a planar metal viewing body having a substantially rectangular main surface and an angled section on two opposite edges of the main surface to thereby give the viewing body a three-dimensional shape. The viewing body has two further outer edges, each having a cut edge which directly adjoins the rectangular main surface of the viewing body.

The invention relates to a support assembly for a household appliance. The invention also relates to a cooktop and a cooking appliance door, in each instance having such a support assembly.

A support assembly can be for example a housing component of a cooking appliance. The support assembly here is at least visible from one side and must therefore satisfy particular esthetic requirements. The support assembly can also serve to secure glass plates or glass ceramic plates.

In the field of household appliances, in particular cooking appliances, glass plates or glass-like plates, such as glass ceramic, are frequently used for various purposes. In a first application a glass ceramic of a cooktop is intended to provide efficient heat transfer from the heat source to a pot for example. Electric heat sources or the induction principle is/are used here. In a second application in the door of a cooking appliance the glass plate, for which a number of parallel glass panes are also frequently used, allows the user to see the items being cooked through the panes and at the same time serves as temperature insulation. In both instances a holder must be provided for the glass plates or glass-like plates.

The object of the present invention is to provide a support assembly for a household appliance, which has a simple and economical structure and is suitable both for a cooktop and for the door of a cooking appliance in respect of its mechanical structure and its appearance.

This object is achieved by a support assembly for use in household appliances, having a planar metal viewing body, which has a substantially rectangular main surface and an angled section on two opposite edges of the main surface, which gives the viewing body a three-dimensional shape. According to the invention the viewing body has a cut edge on the two further outer edges, which directly adjoins the rectangular main surface of the viewing body. The planar viewing body is conventionally angled on all four sides, to give the planar viewing body greater stability by improving the surface inertia moment. It has been inventively identified that this work step can also be omitted. This structure also means that a number of supports of identical design can be disposed next to one another without a gap on the surfaces that have not been processed in such a manner. This creates a flexible module system, with which modules of different widths, in particular cooking modules, can be integrated in a worktop of a line of kitchen units.

There is no provision for an angled section, in particular a fold, pleat or crimp, on the two further outer edges of the planar viewing body. This simplifies the processing of the material.

According to one development of the invention the main surface of the viewing body has a window-type opening. When the support assembly is used for a cooktop a glass ceramic plate can be disposed in said opening and when the support assembly is used for an oven door a glass pane can be disposed therein.

To summarize, a support assembly for use in household appliances is provided here, having a planar metal viewing body and a basic U-shape, in which a rectangular main surface has an angled section on two opposite edges. The main surface here comprises a window-type opening, which is closed off by a glass ceramic plate or the like or by at least one glass pane.

In one preferred embodiment the planar metal viewing body has a material thickness of at least 1.0 mm and at most 3.5 mm, preferably at least 1.5 mm and at most 2.5 mm. Material thicknesses of more than 3.5 mm cannot easily be processed on an industrial scale and processing is complicated even with a material thickness of more than 2.5 mm. Also material costs rise very significantly for such material thicknesses.

A cross-sectional surface of the planar viewing body is visible on at least one of the further outer edges of the main surface. Visibility relates in particular to the incorporated state, in which the planar viewing body is incorporated into an appropriate household appliance, such as a cooktop or a cooking appliance door. The visibility of the cross-sectional or end face surface means that no angling, in particular no folding, pleating or crimping, has been undertaken and this work step has been omitted, thereby reducing production costs. The user can then also see the thickness of the planar viewing body material immediately, which tells him/her that the planar viewing body has sufficient strength to allow a cooking appliance door to be closed firmly for example.

A visible filler body is also disposed between the two angled sections of the main body, at least in the region of one of the further outer edges of the main surface. The filler body, which is preferably made of plastic, is disposed in the region of the relevant further outer edge of the planar viewing body. The filler body prevents dirt getting under the planar viewing body.

An outer contour of the filler body is matched to an inner contour of the viewing body. The filler body therefore rests directly against the viewing body, preferably over its entire length.

The filler body is preferably formed by a screen. The screen is an essentially flat component, which can be made of plastic for example.

The planar metal viewing body is preferably made of corrosion-resistant sheet metal, for example stainless steel sheet or aluminum sheet. Many materials such as aluminum or in particular steel alloys are suitable corrosion-resistant, in other words in particular rust-proof, metals. Steel has the advantage of high strength and a scratch-resistant surface.

The sheet metal of the planar viewing body is visible to the user at its main surface and at least one cross-sectional surface. The visibility of the sheet metal means that there is no need for a surface coating, e.g. lacquer, at this point.

A cooktop plate preferably made of glass ceramic can be disposed in a window-type opening of the viewing body. A glass ceramic plate or the like is therefore enclosed by the planar viewing body in the cooktop.

The subject matter of the invention also includes a cooktop with a support assembly as described above, with a cooktop plate, which is preferably made of glass ceramic, disposed in a window-type opening of the viewing body.

The subject matter of the invention also includes a cooking appliance door with a support assembly as described above, with a viewing window of the cooking appliance door, which is preferably made of glass, disposed in a window-type opening of the viewing body.

Also included in the subject matter of the invention is a combined cooking appliance having a cooking appliance door and a cooktop, each as described above. The combined cooking appliance here can be formed by a freestanding cooker for example. A combined cooking appliance within the meaning of the invention is also a combination of an integrated oven comprising a cooking appliance door and a separate cooktop. If both a cooktop and cooking appliance door with a corresponding planar viewing body are used, then as well as the advantage of a uniform visual appearance, there are also greater cost benefits from the production of more uniform parts.

The invention is described by way of example below based on preferred embodiments and with reference to the drawings, in which:

FIG. 1 shows a cooking appliance in the form of a freestanding appliance,

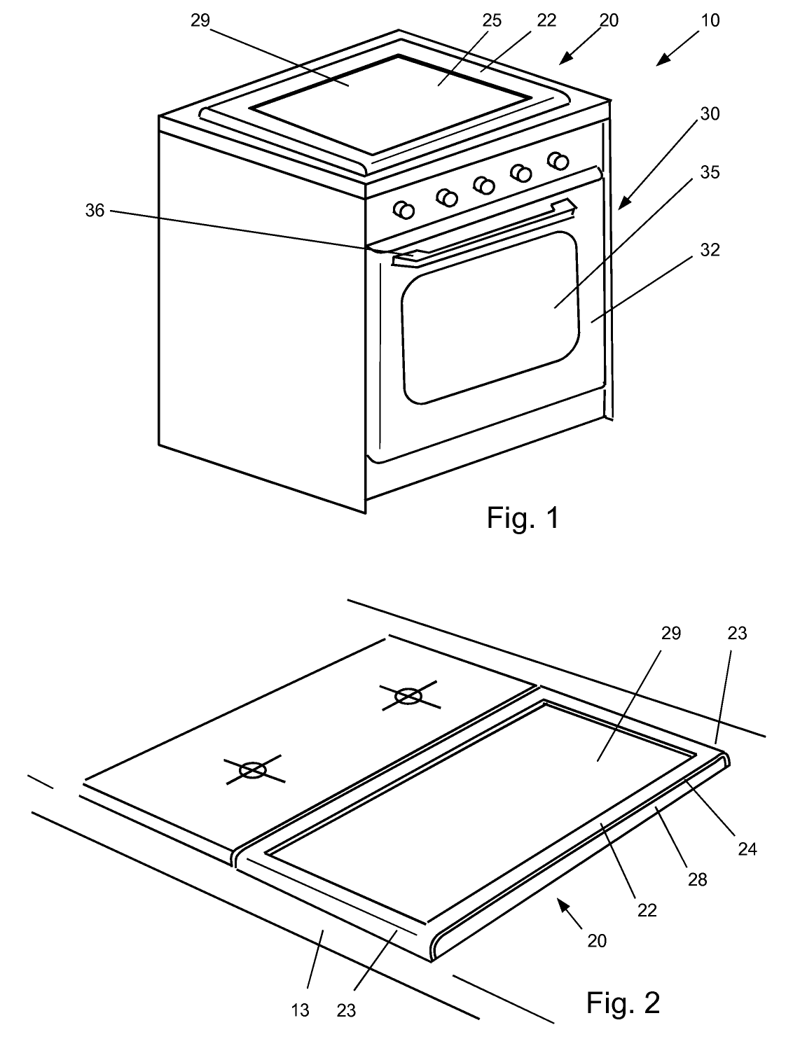

FIG. 2 shows a cut out section from a line of kitchen units with a cooktop and

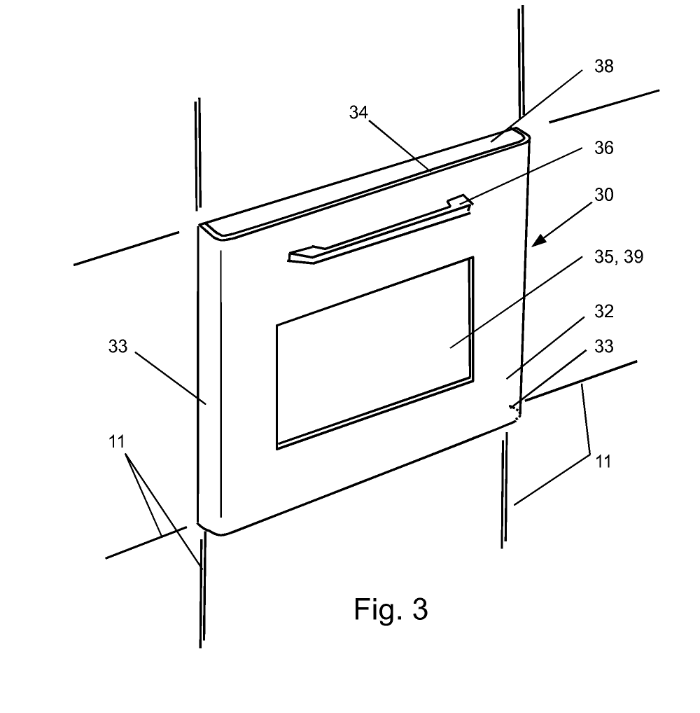

FIG. 3 shows a cut out section from a line of kitchen units with a cooking appliance door shown.

FIG. 1 shows a cooking appliance 10, which has a cooktop 20 and an oven. The oven muffle is closed off by an oven door 30. The oven door can be opened in a pivoting manner (not shown) about a horizontal rotation axis in the lower region of the oven door. Alternatively the oven door can be displaced according to the drawer principle for opening by a parallel movement forward, in other words toward the user, (not shown) or can be pivoted about a vertical axis (not shown). Both the cooktop 20 and the oven door 30 have a U-shaped planar viewing body 22 and 32.

FIG. 2 shows a variant of the incorporation of the cooktop 20 into a line of kitchen units, which is shown symbolically by the worktop 13. The worktop 13 has an insertion opening (not shown) below the cooktop 20, said insertion opening being smaller than the base surface of the cooktop 20. The cooktop 20 has a planar viewing body 22, which has angled sections 23 on the front and rear regions (as viewed by a user). These angled sections 23 ensure the basic U-shape of the planar viewing body 22. The angled sections 23 each describe a 90° angle, so that the cooktop 20 rests with the ends of both flanks of the U-shape on the worktop 13. The planar viewing body 22 is made of stainless steel sheet with a thickness of 1.8 mm, with thicknesses of 1.5 to 3 mm also being able to be used by preference. This material thickness is much greater than the usual thickness generally used for planar viewing bodies, which is around 0.8 mm. The much greater thickness means that a greater torsional strength is achieved and the inserted glass ceramic plate 29 is effectively protected. The arm length of the angled section 23, in other words the distance from the top of the planar viewing body 22 to the worktop 23, is at least 10 mm, preferably 12 to 18 mm.

The cross-sectional surfaces 24 of the viewing body 22 are exposed at the sides of the cooktop 20, at which the planar viewing body 22 has no angled section 23. A filler body 28 is disposed in the region of each cross-sectional surface 24 below the viewing body 22, its size being tailored so that it fills the inner contour of the U-shaped planar viewing body 22 completely. The filler body 28 can be disposed flush with the cross-sectional surface 24 of the planar viewing body 22 or can be offset inward, in other words to the left according to FIG. 2. The filler body 28 ensures that no dirt can get under the cooktop 20 and it is preferably made of a dark plastic. If the planar viewing body 22 is made of stainless steel with a high level of surface quality (e.g. brushed), the customer has an impression of good quality. The customer can see the thickness of the sheet metal immediately from the cross-sectional surface 24. The color contrast of the filler body 28 with the light metal reinforces the impression of good quality. The glass ceramic plate 29 is secured by means of securing means (not shown) to the viewing body 22. Other electric cooktops (not shown) of identical structure or different widths or a gas cooktop 15 can be disposed beside the cooktop 20. If these further cooktops are structured according to the same principle of the planar viewing body 22, they can be lined up without a break, to give an impression of uniformity. Also there are no joins present, in which dirt can collect.

FIG. 3 shows an oven door 30. For the sake of clarity the operating elements of the oven are not shown. Adjacent household appliances 11 or elements of a line of kitchen units, e.g. kitchen cabinets, are indicated with lines instead. The oven door 30 can be opened with the handle 36. When the oven door 30 is in the closed position, the planar viewing body 32 is located in its entirety in front of the plane defined by the adjacent household appliances 11. The user can thus see the sheet thickness of the cross-sectional surface 34 of the planar viewing body 32 immediately. As the sheet metal has a thickness that is identical to the thickness of the planar viewing body 22 of the cooktop, it also gives the impression of a high-quality product. Present in the region of the opening 35 of the planar viewing body 32 are a number of glass panes 39, which allow a user to look into the muffle and which serve as temperature insulation. FIG. 3 shows that the angled sections 33 of the U-shaped planar viewing body 32 are located on the left and right sides of the oven door 30. Alternatively they can be located at the top and bottom. According to FIG. 3 the opening 35 is rectangular in shape. It can also be rounded, as shown in FIG. 1.

The planar viewing body 32 of the oven door is structured according to the same principle as the planar viewing body 22 of the cooktop. This gives an overall impression of uniformity, in particular when the width of the planar viewing bodies 22, 32, in other words the distance between their angled sections, is identical. It also means that production costs can be reduced as a result of uniformity.

### REFERENCE CHARACTERS

10 Household appliance, cooking appliance
11 Adjacent household appliances
13 Worktop
15 Gas cooktop
20 Support assembly, cooktop
22 Planar viewing body of cooktop
24, 34 Cross-sectional surface
23, 33 Angled section
25, 35 Window-type opening
28, 38 Filler body
29 Glass ceramic plate
30 Support assembly, oven door
32 Planar viewing body of oven door
39 Glass pane
36 Handle

1-14. (canceled)

15. A support assembly for use in a household appliance, said support assembly comprising a planar metal viewing body having a substantially rectangular main surface and an angled section on two opposite edges of the main surface to thereby give the viewing body a three-dimensional shape, said viewing body having two further outer edges, each having a cut edge which directly adjoins the rectangular main surface of the viewing body.

16. The support assembly of claim 15, wherein each of the two further outer edges of the viewing body is configured in the absence of an angled section.

17. The support assembly of claim 15, wherein the main surface of the viewing body has a window-type opening.

18. The support assembly of claim 17, further comprising a glass ceramic plate or a glass pane disposed in the window-type opening.

19. The support assembly of claim 15, wherein the planar metal viewing body has a material thickness of at least 1.0 mm and at most 3.5 mm.

20. The support assembly of claim 15, wherein the planar metal viewing body has a material thickness of at least 1.5 mm and at most 2.5 mm.

21. The support assembly of claim 15, wherein the planar viewing body has a cross-sectional surface which is visible on at least one of the further outer edges of the main surface.

22. The support assembly of claim 15, further comprising a visible filler body disposed between the two angled sections of the viewing body at least in a region of one of the further outer edges of the main surface.

23. The support assembly of claim 22, wherein the filler body has an outer contour which matches an inner contour of the viewing body.

24. The support assembly of claim 22, wherein the filler body is formed by a screen.

25. The support assembly of claim 15, wherein the planar metal viewing body is made of corrosion-resistant sheet metal.

26. The support assembly of claim 25, wherein the corrosion-resistant sheet metal is stainless steel sheet or aluminum sheet.

27. The support assembly of claim 25, wherein the sheet metal of the planar viewing body is visible to a user at the main surface and at least one cross-sectional surface of the viewing body.

28. A cooktop, comprising:
a support assembly including a planar metal viewing body having a substantially rectangular main surface and an angled section on two opposite edges of the main surface to thereby give the viewing body a three-dimensional shape, said viewing body having two further outer edges, each having a cut edge which directly adjoins the rectangular main surface of the viewing body, said main surface of the viewing body having a window-type opening; and
a cooktop plate disposed in the window-type opening of the viewing body.

29. The cooktop of claim 28, wherein the cooktop plate is made of glass ceramic.

30. The cooktop of claim 28, wherein each of the two further outer edges of the viewing body is configured in the absence of an angled section.

31. The cooktop of claim 28, wherein the planar metal viewing body has a material thickness of at least 1.0 mm and at most 3.5 mm.

32. The cooktop of claim 28, wherein the planar metal viewing body has a material thickness of at least 1.5 mm and at most 2.5 mm.

33. The cooktop of claim 28, wherein the planar viewing body has a cross-sectional surface which is visible on at least one of the further outer edges of the main surface.

34. The cooktop of claim 28, wherein the support assembly has a visible filler body disposed between the two angled sections of the viewing body at least in a region of one of the further outer edges of the main surface.

35. The cooktop of claim 34, wherein the filler body has an outer contour which matches an inner contour of the viewing body.

36. The cooktop of claim 34, wherein the filler body is formed by a screen.

37. The cooktop of claim 28, wherein the planar metal viewing body is made of corrosion-resistant sheet metal.

38. The cooktop of claim 37, wherein the corrosion-resistant sheet metal is stainless steel sheet or aluminum sheet.

39. The cooktop of claim 37, wherein the sheet metal of the planar viewing body is visible to a user at the main surface and at least one cross-sectional surface of the viewing body.

40. A cooking appliance door, comprising:
a support assembly including a planar metal viewing body having a substantially rectangular main surface and an angled section on two opposite edges of the main surface to thereby give the viewing body a three-dimensional shape, said viewing body having two further outer edges, each having a cut edge which directly adjoins the rectangular main surface of the viewing body, said main surface of the viewing body having a window-type opening; and
a viewing window disposed in the window-type opening of the viewing body.

41. The cooking appliance door of claim 40, wherein the viewing window is made of glass.

42. The cooking appliance door of claim 40, wherein each of the two further outer edges of the viewing body is configured in the absence of an angled section.

43. The cooking appliance door of claim 40, wherein the planar metal viewing body has a material thickness of at least 1.0 mm and at most 3.5 mm.

44. The cooking appliance door of claim 40, wherein the planar metal viewing body has a material thickness of at least 1.5 mm and at most 2.5 mm.

45. The cooking appliance door of claim 40, wherein the planar viewing body has a cross-sectional surface which is visible on at least one of the further outer edges of the main surface.

46. The cooking appliance door of claim 40, wherein the support assembly has a visible filler body disposed between the two angled sections of the viewing body at least in a region of one of the further outer edges of the main surface.

47. The cooking appliance door of claim 46, wherein the filler body has an outer contour which matches an inner contour of the viewing body.

48. The cooking appliance door of claim 46, wherein the filler body is formed by a screen.

49. The cooking appliance door of claim 40, wherein the planar metal viewing body is made of corrosion-resistant sheet metal.

50. The cooking appliance door of claim 49, wherein the corrosion-resistant sheet metal is stainless steel sheet or aluminum sheet.

51. The cooking appliance door of claim 49, wherein the sheet metal of the planar viewing body is visible to a user at the main surface and at least one cross-sectional surface of the viewing body.

52. A combined cooking appliance, comprising:
a cooking appliance door having a support assembly including a planar metal viewing body having a substantially rectangular main surface and an angled section on two opposite edges of the main surface to thereby give the viewing body a three-dimensional shape, said viewing body having two further outer edges, each having a cut edge which directly adjoins the rectangular main surface of the viewing body, said main surface of the viewing body having a window-type opening; and a viewing window disposed in the window-type opening of the viewing body of the support assembly of the cooking appliance; and
a cooktop having a support assembly including a planar metal viewing body having a substantially rectangular main surface and an angled section on two opposite edges of the main surface to thereby give the viewing body a three-dimensional shape, said viewing body having two further outer edges, each having a cut edge which directly adjoins the rectangular main surface of the viewing body, said main surface of the viewing body having a window-type opening; and a cooktop plate disposed in the window-type opening of the viewing body of the support assembly of the cooktop.
